(19) United States
(12) Patent Application Publication
(10) Pub. No.: US 2013/0161163 A1
(43) Pub. Date: Jun. 27, 2013

(54) MULTI-DIRECTIONAL INPUT DEVICE

(71) Applicant: Panasonic Corporation, Osaka (JP)

(72) Inventors: TAKAYA NAKAMURA, Osaka (JP); RYO NAKAE, Osaka (JP)

(73) Assignee: PANASONIC CORPORATION, Osaka (JP)

(21) Appl. No.: 13/709,123

(22) Filed: Dec. 10, 2012

(30) Foreign Application Priority Data
Dec. 21, 2011 (JP) 2011-279423

(51) Int. Cl. H01H 15/02

(52) U.S. Cl. CPC H01H 15/02
USPC 200/16 R

(57) ABSTRACT

An object is to provide a multi-directional input device mainly used for operations of various electronic devices, the multi-directional input device being capable of performing various reliable operations. A movable electrode installed on a lower surface of a sliding body which is engaged with a lower end of an operation body is connected to a ground, and a plurality of fixed electrodes arranged so as to face the movable electrode with a predetermined gap is arranged at predetermined intervals. Thereby, the plurality of fixed electrodes facing the movable electrode can be formed in a large shape, so that a change in a capacitance due to operations of the operation body can be increased. As a result, not only the operating direction but also an operation amount can be precisely detected. Thus, the multi-directional input device capable of performing various reliable operations can be obtained.

### BACKGROUND

1. Technical Field

The technical field relates to a multi-directional input device mainly used for operations of various electronic devices.

2. Description of the Related Art

In recent years, various electronic devices such as mobile phones and personal computers increasingly become more functional and more diversified. A multi-directional input device which is operable in multiple directions is installed in these electronic devices. The number of such kind of the electronic device in which various functions are switched by this multi-directional input device is increasing, and an easily used device capable of performing reliable operations is desired.

Such a conventional multi-directional input device will be described with reference to FIG. 10.

FIG. 10 is a perspective view of conventional multi-directional input device 10.

Multi-directional input device 10 is provided with case 1, operation body 2, and wiring substrate 3.

Case 1 is formed in a substantially box shape and made of insulating resin. Insulating-resin operation body 2 is installed on an upper surface of case 1 oscillatably in multiple directions.

A plurality of wiring patterns (not shown) are formed on wiring substrate 3, and case 1 is arranged on an upper surface of wiring substrate 3. A plurality of switch contacts (not shown) and the like are formed on the upper surface of wiring substrate 3 in case 1.

Multi-directional input device 10 is installed in an electronic device together with a light-transmissive touchscreen and the like. The plurality of switch contacts in case 1 are electrically connected to an electronic circuit (not shown) in the electronic device via the wiring patterns, connectors (not shown), or the like.

When an operator oscillates operation body 2 in the front, rear, left, and right directions, or the direction in the middle of the directions while watching display of liquid crystal display elements on a back surface of the touchscreen, electric touch and separation of the plurality of switch contacts in case 1 are performed. Thereby, the electronic circuit detects the operating direction of operation body 2, so that various functions of the electronic device are switched.

Specifically, when operation body 2 is tilted in various directions in a state where for example a plurality of menus and the like are displayed by the display elements on the back surface of the touchscreen, the electronic circuit detects this. Thereby, a cursor, a pointer, or the like displayed by the display elements is moved in the operated direction, so that a desired menu is selected or the like.

### SUMMARY

However, in the conventional multi-directional input device, the operating direction of operation body 2 is detected by the electric touch and separation of the plurality of switch contacts in case 1. Therefore, many switch contacts are required, a configuration is also complicated, and there is a problem that an operation amount indicating to what extent operation body 2 is oscillated is not easily precisely detected.

A multi-directional input device of a preferable mode has a substantially box shape case, an operation body installed in the case so as to be operable in multiple directions, a sliding body engaged with a lower end of the operation body, and a movable electrode installed on a lower surface of the sliding body. The multi-directional input device further has a plurality of fixed electrodes arranged so as to face the movable electrode with a predetermined gap, the movable electrode is connected to a ground, and the plurality of fixed electrodes are arranged at predetermined intervals. Since the movable electrode is connected to the ground, the plurality of fixed electrodes facing the movable electrode can be formed in a large shape, so that a change in a capacitance due to operations of the operation body can be increased. Therefore, not only the operating direction but also an operation amount can be precisely detected. Thus, there is an effect that the multi-directional input device capable of performing various reliable operations can be obtained.

### BRIEF DESCRIPTION OF DRAWINGS

FIG. 1 is a sectional view of a multi-directional input device according to an embodiment;

FIG. 2 is an exploded perspective view of the multi-directional input device according to the embodiment;

FIG. 3A is a perspective view of an assembling step of a unit body according to the embodiment;

FIG. 3B is a perspective view of the unit body according to the embodiment;

FIG. 4A is a perspective view of an assembling step of the multi-directional input device according to the embodiment;

FIG. 4B is a perspective view of the assembling step of the multi-directional input device according to the embodiment;

FIG. 5 is a sectional view for illustrating operations of the multi-directional input device according to the embodiment;

FIG. 6A is a plan fragmentary view for illustrating the operations of the multi-directional input device according to the embodiment;

FIG. 6B is a plan fragmentary view for illustrating the operations of the multi-directional input device according to the embodiment;

FIG. 6C is a plan fragmentary view for illustrating the operations of the multi-directional input device according to the embodiment;

FIG. 6D is a plan fragmentary view for illustrating the operations of the multi-directional input device according to the embodiment;

FIG. 6E is a plan fragmentary view for illustrating the operations of the multi-directional input device according to the embodiment;

FIG. 7 is an exploded perspective fragmentary view of the multi-directional input device according to the embodiment;

FIG. 8 is an exploded perspective fragmentary view of the multi-directional input device according to the embodiment;

FIG. 9 is an exploded perspective fragmentary view of the multi-directional input device according to the embodiment; and

FIG. 10 is a perspective view of a conventional multi-directional input device.

### DETAILED DESCRIPTION OF THE PREFERRED EMBODIMENT

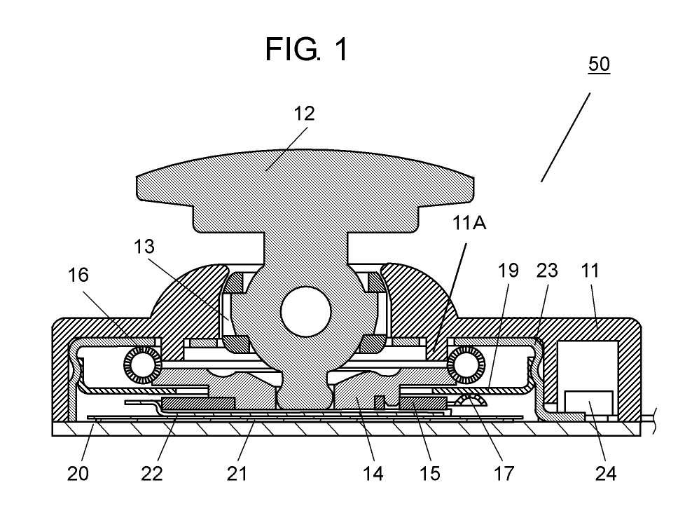

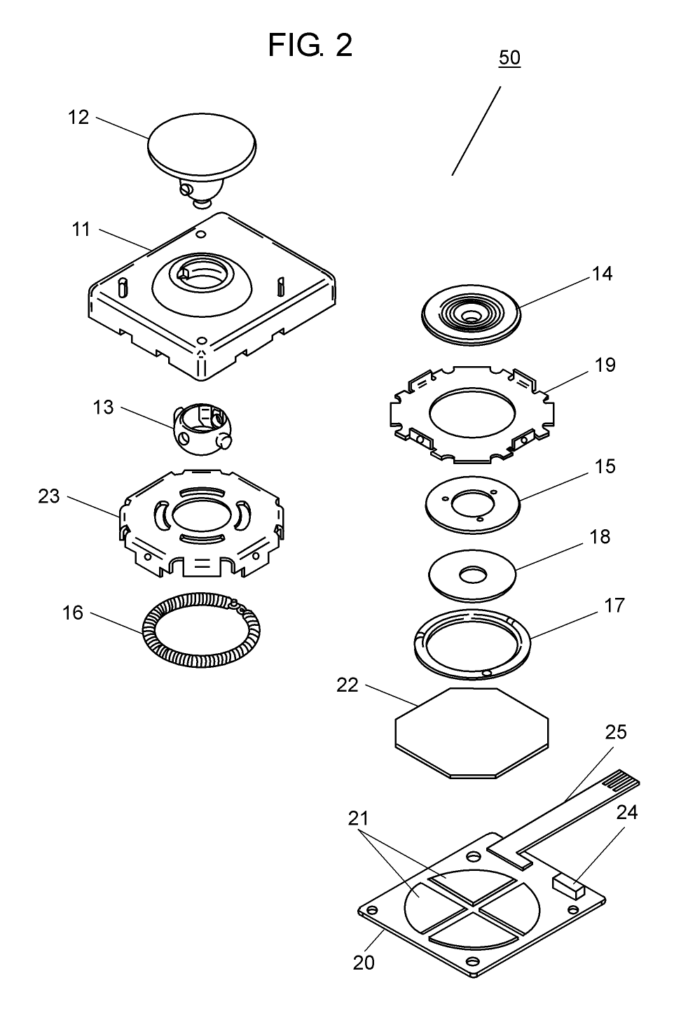

FIG. 1 is a sectional view of multi-directional input device 50 according to an embodiment, and FIG. 2 is an exploded perspective view of multi-directional input device 50 according to the embodiment.

Case 11 is formed in a substantially box shape whose lower surface is open and made of insulating resin such as ABS and polybutylene terephthalate. Operation body 12 is made of insulating resin such as polyoxymethylene and ABS. A lower part of operation body 12 is inserted into case 11 through an insertion hole in a center of an upper surface.

Oscillation body 13 is formed in a substantially cylinder shape and made of insulating resin. A pivot shaft of an outer periphery of oscillation body 13 is inserted into a support hole of case 11, so that oscillation body 13 is locked onto case 11 oscillatably in the left and right direction. A pivot shaft of an outer periphery of operation body 12 is inserted into a support hole of oscillation body 13, so that operation body 12 is locked onto oscillation body 13 oscillatably in the front and rear direction. Thereby, operation body 12 is installed in case 11 oscillatably in multiple directions.

Sliding body 14 is made of insulating resin, and retaining body 15 is formed in a substantially ring shape and made of insulating resin. Retaining body 15 is locked onto a lower surface of sliding body 14, and a lower end of operation body 12 is inserted into a through hole in a center of sliding body 14.

Steel-wire spring 16 is wound into a coil shape and formed in a substantially ring shape. An inner periphery of spring 16 is abutted with claw portions 11A of the lower surface of case 11 and an outer periphery of sliding body 14, so that sliding body 14 and operation body 12 are retained at a center position.

Movable electrode 17 is formed in a substantially disc shape and made of a copper alloy or a steel plate. Spacer 18 is formed in a film shape and made of polyethylene terephthalate or the like. Movable electrode 17 is fixed onto a lower surface of retaining body 15 with an adhesive of acrylic, rubber, or the like applied onto upper and lower surfaces of spacer 18.

Ground plate 19 made of a copper alloy or a steel plate is arranged between sliding body 14 and retaining body 15. An outer periphery of an upper surface of movable electrode 17 is elastically connected to a lower surface of ground plate 19 in a slightly warped state.

Wiring substrate 20 is made of phenolic paper, glass epoxy, or the like. A plurality of wiring patterns (not shown) are provided on upper and lower surfaces of wiring substrate 20 by copper-foiling or the like. Four substantially fan-shaped fixed electrodes 21 made of a copper alloy or the like and arranged in a radial manner at predetermined intervals are formed on the upper surface of wiring substrate 20.

Sheet 22 has a thickness of about 10 μm to 50 μm and is made of polyethylene, Teflon (registered trademark), or the like. Sheet 22 is fixed onto the upper surface of wiring substrate 20 so as to cover four fixed electrodes 21. Movable electrode 17 is arranged on sheet 22, and thereby, fixed electrodes 21 and movable electrode 17 are arranged so as to face each other with a predetermined gap.

Shield plate 23 is made of a copper alloy or a steel plate and arranged on the upper surface of wiring substrate 20 so as to cover sliding body 14, retaining body 15, movable electrode 17, and the like. A lower end of shield plate 23 is connected to the wiring patterns by soldering or the like. Claw portions 11A of the lower surface of case 11 are inserted into through holes of an upper surface of shield plate 23. An outer periphery of ground plate 19 is elastically connected to an inner side wall of shield plate 23 in a slightly warped state.

That is, the outer periphery of the upper surface of movable electrode 17 is elastically connected to the lower surface of ground plate 19, and the outer periphery of ground plate 19 is elastically connected to shield plate 23. Since shield plate 23 is connected to the wiring patterns, movable electrode 17 is connected to a ground via ground plate 19 and shield plate 23.

Control circuit 24 is a semiconductor device such as a microcomputer mounted on wiring substrate 20. Control circuit 24 is connected to four fixed electrodes 21 via the wiring patterns.

In flexible printed circuit 25, a plurality of conductive patterns of copper foil, silver, carbon, or the like are formed on one surface or upper and lower surfaces of a film made of polyethylene terephthalate, polyimide, or the like. One end of the conductive patterns is connected to the wiring patterns of wiring substrate 20 with an anisotropically conductive adhesive in which a plurality of conductive particles formed by gilding nickel, resin, or the like is dispersed in synthetic resin of epoxy, acrylic, polyester, or the like, and the like. The other end of the conductive patterns extends to the outer side of the multi-directional input device.

Wiring substrate 20 is attached to case 11 with screws (not shown) and the like so as to cover an opening part of the lower surface of case 11.

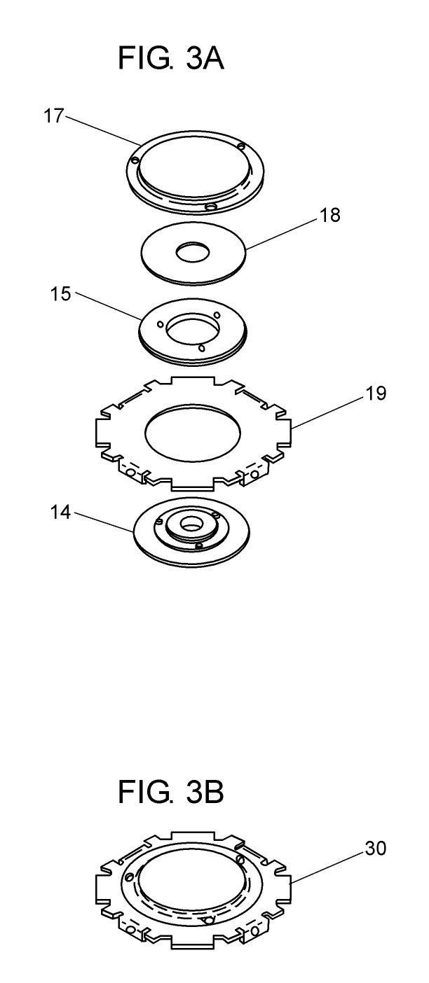

At the time of manufacturing multi-directional input device 50, as shown in a perspective view of FIG. 3A, sliding body 14 and retaining body 15 are firstly locked while sandwiching ground plate 19 between the bodies. After that, movable electrode 17 is fixed to retaining body 15 with spacer 18 interposed therebetween so as to manufacture unit body 30 as shown in FIG. 3B.

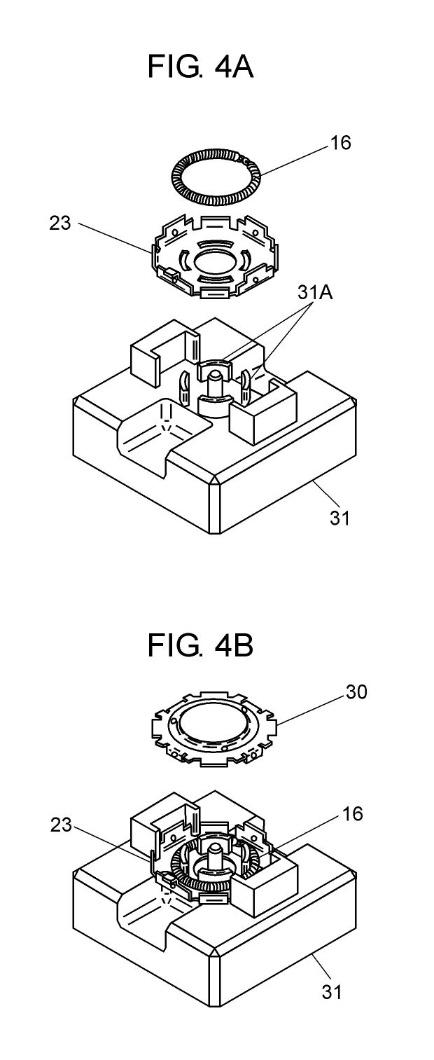

Next, as shown in a perspective view of FIG. 4A, shield plate 23 and spring 16 are arranged in jig 31 in which claw portions 31A similar to case 11 are formed on an upper surface. After that, as shown in FIG. 4B, unit body 30 is combined from the top.

Next, after unit body 30 combined with shield plate 23 and spring 16 is removed from jig 31, wiring substrate 20 in which sheet 22, control circuit 24, and flexible printed circuit 25 are installed, and case 11 in which operation body 12 and oscillation body 13 are assembled are combined with the unit body from the upper and lower sides. Thereby, multi-directional input device 50 is completed.

That is, parts excluding a block of wiring substrate 20 and case 11 are assembled with using jig 31, and the block of wiring substrate 20 and case 11 is combined with this. Thereby, the multi-directional input device can be easily manufactured.

Multi-directional input device 50 formed as above is installed in an electronic device together with a light-transmissive touchscreen and the like. The other end of flexible printed circuit 25 extending to the outer side of multi-directional input device 50 is connected to an electronic circuit (not shown) in the electronic device via connectors (not shown) or the like, so that control circuit 24 and fixed electrodes 21 are electrically connected to the electronic circuit.

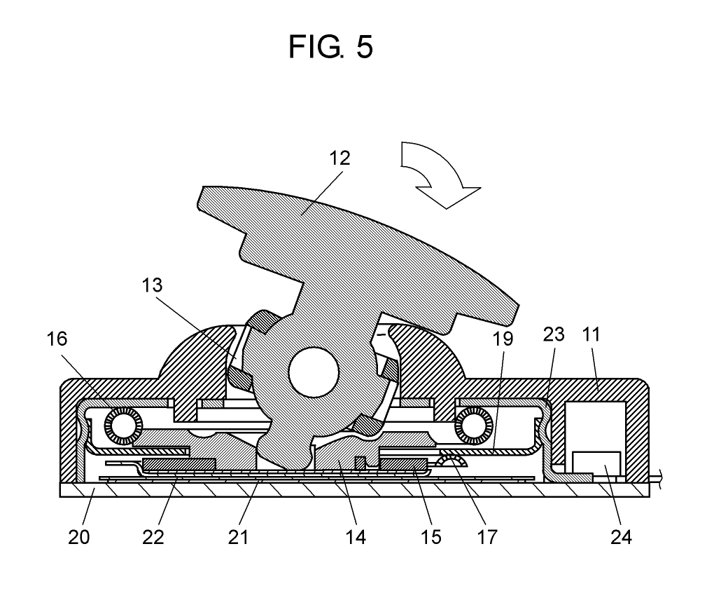

While watching display of display elements such as liquid crystal display elements on a back surface of the touchscreen, an operator tilts operation body 12 by hand in the predetermined direction such as rightward as shown in a sectional view of FIG. 5, in a state where predetermined voltage is applied to fixed electrodes 21.

When operation body 12 is operated, the lower end of operation body 12 is tilted leftward, and sliding body 14 in which this lower end is engaged with the through hole in the center is moved leftward while warping spring 16 abutted with the outer periphery. Therefore, retaining body 15 and movable electrode 17 on the lower surface of sliding body 14 also slide leftward on sheet 22. Thereby, an area where substantially disc-shaped movable electrode 17 faces four substantially fan-shaped fixed electrodes 21 arranged on the upper surface of wiring substrate 20 in a radial manner is changed.

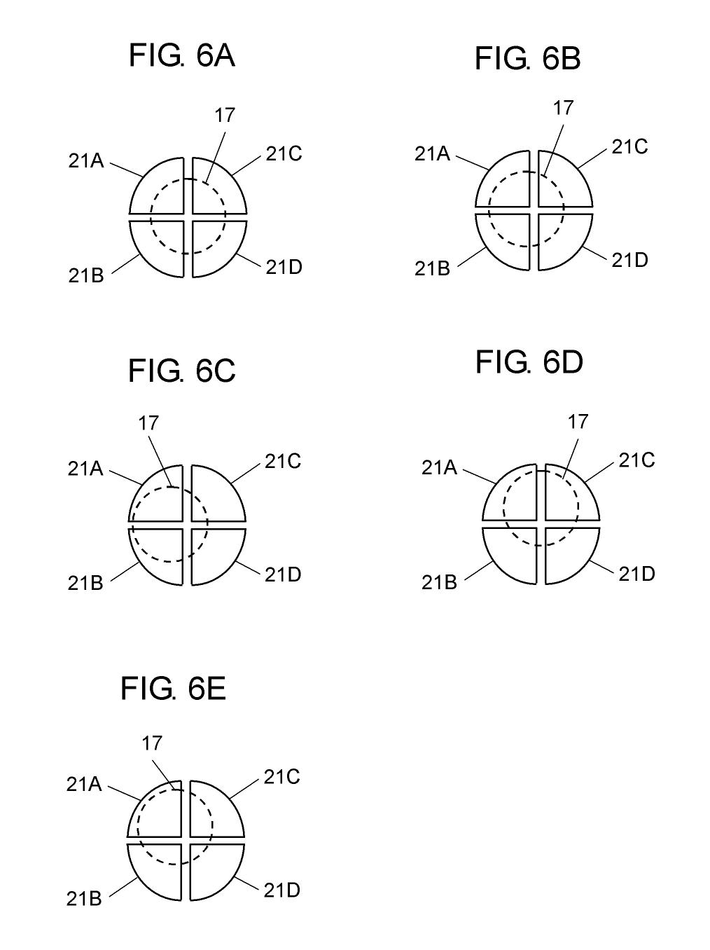

That is, as shown in a plan fragmentary view of FIG. 6A, in a case where operation body 12 is not operated and movable electrode 17 is placed at the center position, the areas where four fixed electrodes 21A, 21B, 21C, and 21D face movable electrode 17, that is, the areas where the fixed electrodes overlie the movable electrode are equal. As shown in FIGS. 6B and 6C, as movable electrode 17 slides leftward, the areas where four fixed electrodes 21A, 21B, 21C, and 21D face movable electrode 17 are changed. That is, the areas where left fixed electrodes 21A and 21B face movable electrode 17 are changed to be increased, and the areas where right fixed electrodes 21C and 21D face movable electrode 17 are changed to be decreased.

In accordance with this change, values of capacitances between movable electrode 17 and four fixed electrodes 21 are changed. The capacitances of fixed electrodes 21A and 21B having the large facing area are increased, and the capacitances of fixed electrodes 21C and 21D having the small facing area are decreased.

In a case where operation body 12 is oscillated rearward and movable electrode 17 slides forward, as shown in FIG. 6D, the areas facing movable electrode 17 are increased and the capacitances are increased regarding fixed electrodes 21A and 21C, and the areas of facing movable electrode 17 are decreased and the capacitances are decreased regarding fixed electrodes 21B and 21D.

In a case where operation body 12 is oscillated right-rearward which is in the middle of rightward and rearward and movable electrode 17 slides left-forward, as shown in FIG. 6E, fixed electrode 21A has the largest area facing movable electrode 17, fixed electrodes 21B and 21C have the second largest area, and fixed electrode 21D has the smallest area. Each of fixed electrodes 21A to 21D has a capacitance value corresponding to this facing area.

By the change in the capacitances of four fixed electrodes 21, control circuit 24 detects the operating direction of operation body 12 and an operation amount indicating to what extent the operation body is tilted and outputs a predetermined signal to the electronic circuit, so that various functions of the device are switched.

When the hand is removed from operation body 12 so as to cancel an operation force, an inner periphery is abutted with the claw portions of the lower surface of case 11 and the outer periphery of sliding body 14, and sliding body 14 is returned to the center position by an elastic return force of spring 16 warped by sliding body 14 which is moved in the opposite direction to the operating direction. Thereby, operation body 12 is returned to the original center position.

That is, when operation body 12 is tilted in various directions in a state where for example a plurality of menus and the like are displayed by the display elements on the back surface of the touchscreen, control circuit 24 detects the operating direction and the operation amount of operation body 12 and outputs the predetermined signal to the electronic circuit. Thereby, a cursor, a pointer, or the like displayed by the display elements is moved in the operated direction by an operated amount, so that a desired menu is selected or the like.

In multi-directional input device 50, ground plate 19 is provided on the lower side of sliding body 14, and substantially disc-shaped movable electrode 17 is elastically connected to ground plate 19. Fixed electrodes 21 are arranged in a radial manner at predetermined intervals, and the plurality of fixed electrodes 21 are formed in a substantially fan shape. Thus, the area where movable electrode 17 sliding in accordance with operations of operation body 12 faces the plurality of fixed electrodes 21 can be increased. Therefore, the change in the capacitance is increased, so that the operating direction and the operation amount of operation body 12 can be precisely detected.

For example, in a case where a plurality of substantially fan-shaped ground electrodes are arranged in a radial manner between the plurality of fixed electrodes 21, a shape of fixed electrodes 21 is decreased by an amount of the ground electrodes.

Meanwhile, movable electrode 17 is connected to the ground via ground plate 19 elastically connected to movable electrode 17 and shield plate 23 elastically connected to ground plate 19 and connected to the wiring patterns of wiring substrate 20. Thus, as described above, fixed electrodes 21 can be formed as four fixed electrodes 21A, 21B, 21C, and 21D having a large area.

That is, ground plate 19 is provided and movable electrode 17 is elastically connected to ground plate 19, so that movable electrode 17 is connected to the ground. Thereby, the plurality of substantially fan-shaped fixed electrodes 21 arranged in a radial manner are formed in a large shape, so that the area of facing substantially disc-shaped movable electrode 17 and the change in the capacitance due to the operations of operation body 12 can be increased. Therefore, not only the operating direction of operation body 12 but also the operation amount can be precisely detected.

Sheet 22 is fixed onto the upper surface of wiring substrate 20 so as to cover fixed electrodes 21. By arranging movable electrode 17 on sheet 22 and making the movable electrode slide, movable electrode 17 smoothly slides in accordance with the operations of operation body 12 without a catching feel due to sheet 22. Thereby, an operation feel of operation body 12 can become favorable.

The configuration that control circuit 24 is formed by a microcomputer or the like in wiring substrate 20 and control circuit 24 detects the change in the capacitance of fixed electrodes 21 due to the operations of operation body 12 is described above. The present invention is not limited to this, but the plurality of fixed electrodes 21 may be directly connected to the electronic circuit of the device, so that a microcomputer of the electronic circuit detects the operating direction and the operation amount of operation body 12.

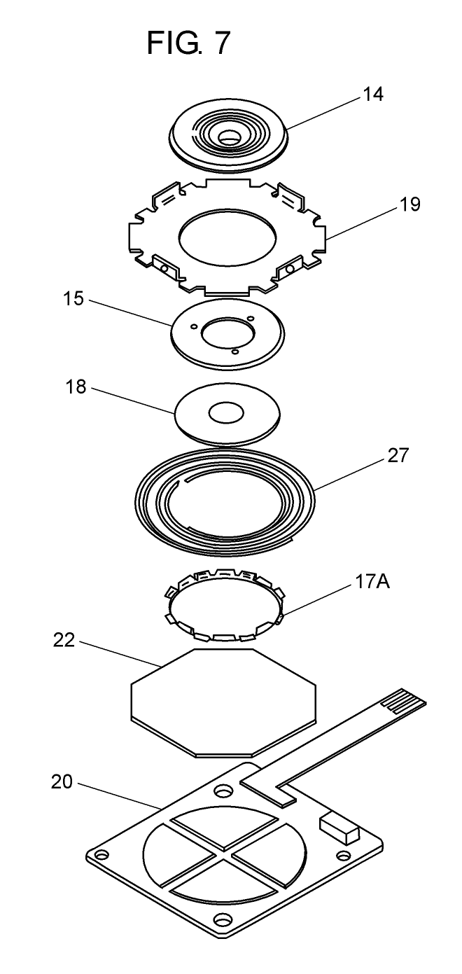

The configuration that the outer periphery of the upper surface of movable electrode 17 is elastically connected to the lower surface of ground plate 19 on the lower side of sliding body 14 so as to be connected to the ground is described above. The present invention is not limited to this, but as shown in an exploded perspective fragmentary view of FIG. 7, spring 27 in which a steel wire or the like is wound in a spiral shape is provided between ground plate 19 and movable electrode 17A. Spring 27 may be elastically connected to the lower surface of ground plate 19 and movable electrode 17A in a slightly warped state, so that movable electrode 17A is connected to the ground.

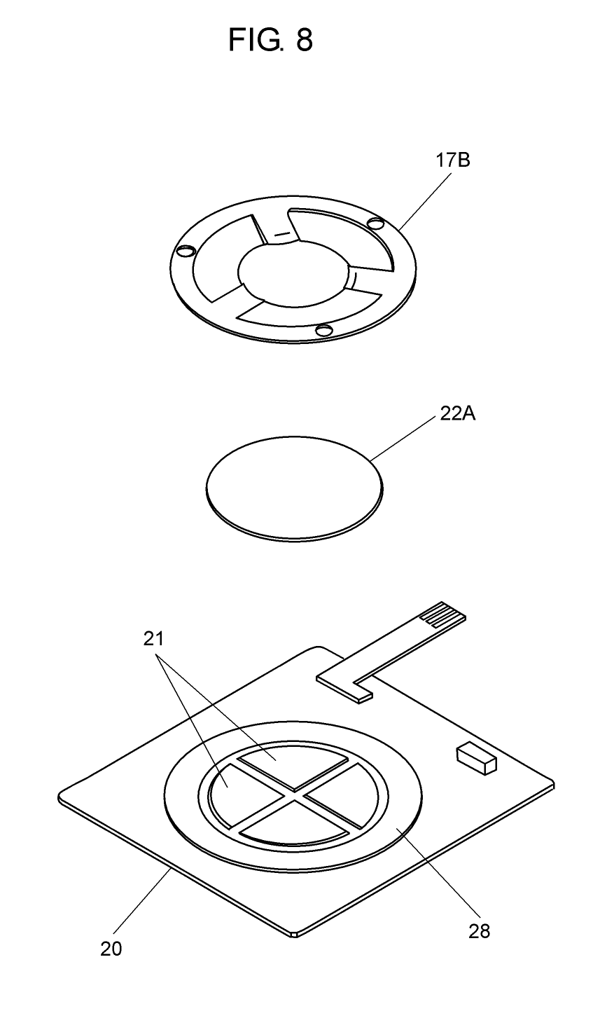

As shown in an exploded perspective fragmentary view of FIG. 8, in place of ground plate 19, substantially ring-shaped ground electrode 28 is provided on the upper surface of wiring substrate 20 so as to surround the plurality of fixed electrodes 21. Sheet 22A may be fixed onto the upper surface of wiring substrate 20 so as to cover fixed electrodes 21 and an outer periphery of a lower surface of movable electrode 17B may be elastically connected to ground electrode 28, so that movable electrode 17B is connected to the ground.

The fixed electrodes 21 may be formed in various shapes other than the substantially fan shape such as a substantially rectangular shape and a substantially triangle shape.

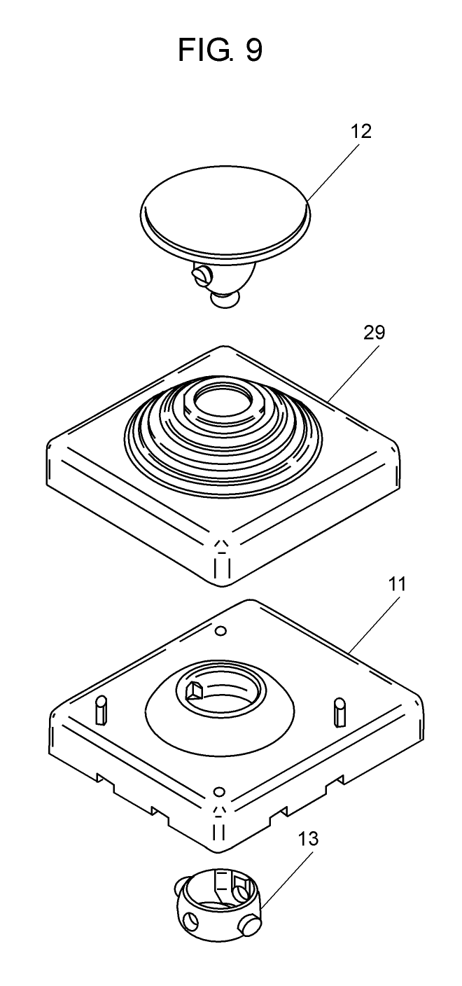

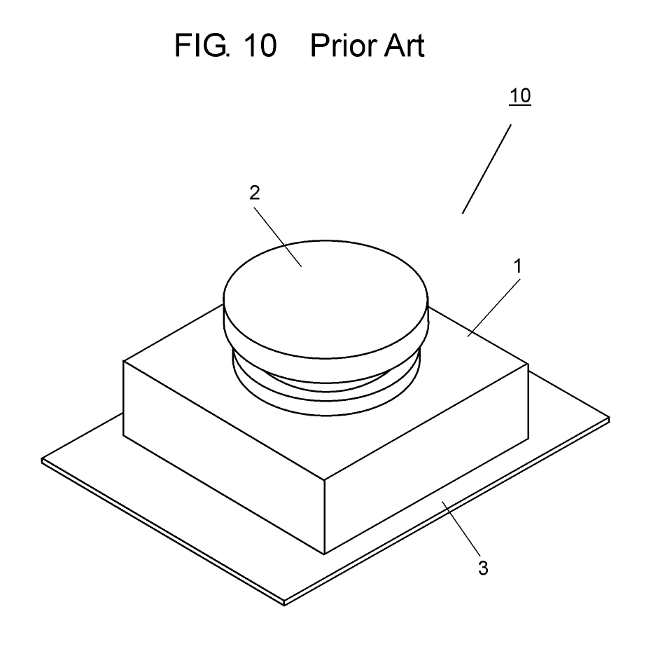

As shown in an exploded perspective fragmentary view of FIG. 9, substantially dome-shaped cover 29 made of rubber, elastomer, or the like is provided, and an opening hole in an upper end thereof is press-fitted to an outer periphery of an intermediate part of operation body 12. By forming cover 29 so as to cover entire case 11, a water-proof property and a dust-proof property are enhanced, so that more reliable operations can be realized.

As described above, movable electrode 17 installed on the lower surface of sliding body 14 which is engaged with the lower end of operation body 12 is connected to the ground. The plurality of fixed electrodes 21 arranged so as to face movable electrode 17 with a predetermined gap are arranged at predetermined intervals. Thereby, the plurality of fixed electrodes 21 facing movable electrode 17 can be formed in a large shape, so that the change in the capacitance due to the operations of operation body 12 can be increased. Therefore, not only the operating direction but also the operation amount can be precisely detected. Thus, multi-directional input device 50 capable of performing various reliable operations can be obtained.

What is claimed is:

1. A multi-directional input device, comprising:
a case formed in a substantially box shape;
an operation body installed in the case so as to be operable in multiple directions;
a sliding body engaged with a lower end of the operation body;
a movable electrode installed on a lower surface of the sliding body and connected to a ground; and
a plurality of fixed electrodes separated from each other and arranged so as to be separated from and face the movable electrode.

2. The multi-directional input device according to claim 1, wherein the plurality of fixed electrodes are four fixed electrodes.

3. The multi-directional input device according to claim 1, wherein each of the plurality of fixed electrodes is formed in a substantially fan shape.

4. The multi-directional input device according to clam 1, wherein the plurality of fixed electrodes are made of a copper alloy.

5. The multi-directional input device according to claim 1, further comprising:
a sheet provided between the plurality of fixed electrodes and the movable electrode.

6. The multi-directional input device according to claim 5, wherein a thickness of the sheet is 10 μm to 50 μm.

7. The multi-directional input device according to claim 5, wherein the sheet contains polyethylene or Teflon.
